(19) United States
(12) Patent Application Publication
(10) Pub. No.: US 2024/0008137 A1
(43) Pub. Date: Jan. 4, 2024

(54) RADIO ACCESS NETWORK CONNECTION TIME MANAGEMENT AT USER EQUIPMENT

(71) Applicant: GOOGLE LLC, Mountain View, CA (US)

(72) Inventors: Blake Kragten, San Diego, CA (US); Shivank Nayak, Milpitas, CA (US); Siddharth Ray, Sunnyvale, CA (US)

(21) Appl. No.: 18/039,332

(22) PCT Filed: Dec. 1, 2020
(86) PCT No.: PCT/US2020/062650

§ 371 Date: May 30, 2023

(51) Int. Cl. H04W 76/28; H04W 76/15; H04W 52/02

(52) U.S. Cl. CPC H04W 76/28; H04W 76/15; H04W 52/0216

(57) ABSTRACT

A user equipment (UE) identifies, a minimum connection time for a first radio access network (RAN) and connects the UE to the first RAN for a first time and to a second RAN for a second time. The first time and the second time are based on the minimum connection time. The UE thereby ensures that the UE is connected to the first RAN for at least the minimum connection time.

### BACKGROUND

Wireless communication devices such as cellular phones, tablets, and computers frequently are configured to wirelessly connect to a packet data network (PDN), such as the Internet. To enhance the reliability, flexibility, and geographical scope of PDN connections, a wireless communication device can support multiple types of wireless connections. For example, some smartphones include different interfaces supporting connections with different networks, wherein each network is associated with a specified Radio Access Technology, such as a Third Generation Partnership Project (3GPP) Long Term Evolution (LTE) RAT implementation, or a 3GPP Fifth Generation (5G) New Radio (NR) RAT implementation.

Maintaining a connection to some RANs can require a wireless communication device to consume a relatively high amount of power. Accordingly, some wireless communication devices employ power management schemes that connect to different ones of the available RANs based on specified criteria, such as bandwidth requirements, power consumption, and the like. However, existing power management schemes can limit connectivity to one or more of the available RANs, resulting in a poor user experience.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a communication network including a user equipment (UE) that selects between different RANs based on a specified minimum connection time for at least one of the RANs in accordance with some embodiments.

FIG. 2 is a diagram illustrating an example of the UE of FIG. 1 maintaining connection to a selected RAN for a specified minimum amount of time.

FIG. 3 is a block diagram illustrating an example of the UE of FIG. 1 that selects a RAN connection based on a specified connection pattern in accordance with some embodiments.

FIG. 4 is a flow diagram of a method of a UE selecting RAN connections based on a specified connection pattern in accordance with some embodiments.

FIG. 5 is a block diagram illustrating an example of the UE of FIG. 1 that selects a RAN connection based on a minimum threshold connection time in accordance with some embodiments.

FIG. 6 is a flow diagram of a method of a UE selecting a RAN connection based on a minimum threshold connection time in accordance with some embodiments.

FIG. 7 is a block diagram illustrating an example of the UE of FIG. 1 that selects a RAN connection based on accumulating connection tokens in accordance with some embodiments.

FIG. 8 is a flow diagram of a method of a UE selecting a RAN connection based on accumulating connection tokens in accordance with some embodiments.

### DETAILED DESCRIPTION

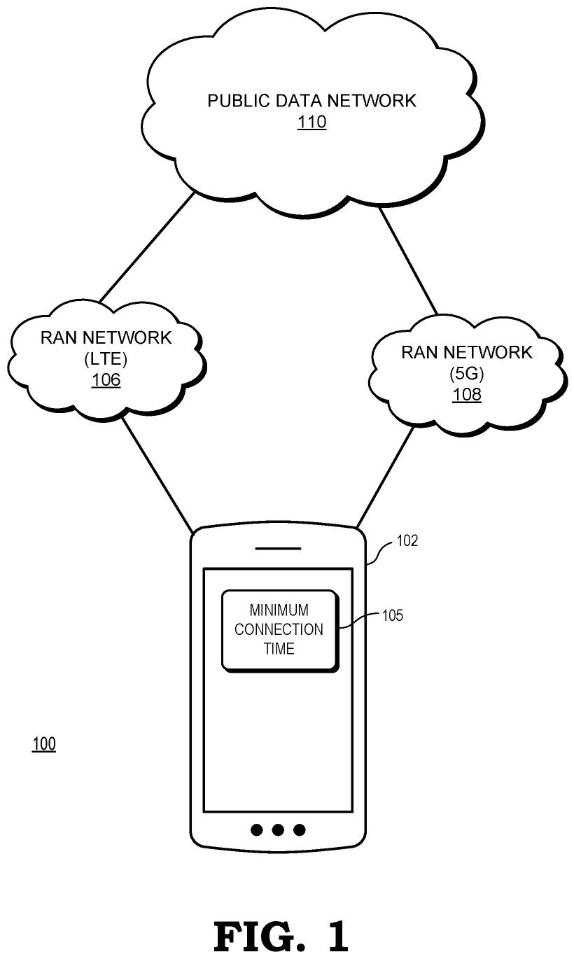

FIGS. 1-8 illustrate techniques for implementing RAN selection schemes at a UE so that the UE maintains connection to a specified RAN, such as a 5G RAN, for a minimum amount of time over a specified time period. By employing one or more of the disclosed techniques, the UE can ensure connection to the specified RAN, and the corresponding network services and attributes, for at least the minimum amount of time. The UE thereby ensures that the user of the UE has access to the network services and attributes for the minimum amount of time, and thus improves the user experience.

To illustrate the improved experience via an example, conventional UE power management schemes select from among available networks based on a set of specified criteria, such as UE power consumption and network throughput. Thus, if the applications executing at the UE require a high amount of network throughput, the UE connects to the RAN (e.g., a 5G RAN) having higher network throughput, causing the UE to consume a higher amount of power. If the applications executing at the UE require a low amount of network throughput, the UE connects to the RAN (e.g., an LTE RAN) having a lower network throughput, causing the UE to consume a lower amount of power. The UE thus balances the throughput needs of the executing applications with power consumption. However, in some cases, this power management scheme can result in the UE connecting to the high-throughput RAN rarely (or never). This can result in poor user experience, such as when the user is paying subscription fees for the higher-throughput RAN. By using the techniques described herein, the UE can ensure connection to the higher-throughput RAN for at least a minimum amount of time, thereby improving the user experience with the UE.

In different embodiments, the UE enforces the minimum connection time in different ways. For example, in some embodiments, the UE stores a specified pattern of connection times to a plurality of RANs, and employs a set of timers to ensure that the UE is connected to each of the plurality of RANs based on the specified pattern. One timer establishes the time that the RAN is required to be connected to, for example, the 5G RAN, and the other timer establishes the time that the RAN is permitted to disconnect from the 5G RAN based on throughput demands or other connection criteria. The UE initializes the timers based on the specified pattern of connection times, thereby ensuring that the UE is connected to the 5G RAN for at least the minimum connection time indicated by the pattern. In at least some embodiments, the pattern is specified by a network carrier associated with the UE to ensure a satisfactory user experience. In other embodiments, the UE sets the pattern for each time period (e.g., each 24-hour period) based on the connection pattern established over the previous time period (e.g., the previous 24-hour period).

In other embodiments, the UE enforces the minimum connection time using an allowed time system. At the start of a specified time period (e.g., at the start of each 24-hour period), the UE operates in a connection decision mode, wherein the UE is permitted to connect and disconnect from the 5G RAN based on power management criteria such as throughput demands. The UE maintains a count indicative of the amount of time the UE has disabled connection to the 5G RAN. In response to the 5G disabled time exceeding a specified threshold, the UE connects to the 5G RAN and prevents the 5G RAN connection from being disabled until the end of the specified time period. The UE thus ensures a connection to the 5G RAN for at least the minimum connection time indicated by the specified threshold. In some embodiments, a network carrier associated with the UE sets the specified threshold in order to ensure a good user experience.

In still other embodiments, the UE enforces the minimum connection time using a token credit system, wherein the UE accumulates tokens when the UE is connected to the 5G RAN, and decrements the accumulated tokens when the UE has disabled connection to the 5G RAN based on power management criteria. When the number of accumulated tokens is reduced to a threshold level (e.g., zero), the UE connects to the 5G RAN and prevents the 5G RAN connection from being disabled until a threshold number of tokens have been accumulated. An operating system or other module of the UE sets the token accumulation rate and token reduction rate to establish the minimum connection time to the 5G RAN. By employing the token credit system, the UE is able to tailor connection times for a variety of use patterns, and a variety of corresponding users, while still enforcing the minimum connection time requirement.

FIG. 1 illustrates a communication network 100 implementing minimum connection time for a selected RAN in accordance with some embodiments. As shown in FIG. 1, the communication network 100 includes a user equipment (UE) 102 that is capable of connecting to a public data network (PDN) 110 via multiple wireless network connections. The UE 102 can include any of a variety of electronic wireless communication devices, such as a cellular phone, a cellular-enabled tablet computer or cellular-enabled notebook computer, an automobile or other vehicle employing cellular services (e.g., for navigation, provision of entertainment services, in-vehicle mobile hotspots, etc.), and the like. The PDN 110 is the Internet, one or more private interconnecting data networks, or a combination thereof.

The UE 102 is configured to establish network connections with the PDN 110 via at least two different RAN connections 106 and 108. In some embodiments, the UE 102 can also establish a network connection with the PDN 110 via other network connections, such as via other RANs not illustrated at FIG. 1, via a Wi-Fi connection through a wireless access point (WAP) that complies with an IEEE 802.11 protocol or its successors, such as one or more of the IEEE 802.11a, 802.11b, 802.11g, 802.11n, and 802.11ac protocols.

The RANs 106 and 108 are radio access networks that support wireless connections with a backhaul infrastructure including a corresponding core network (not shown), with the core network providing a further connection to the PDN 110. To provide connections to the core network, the RANs 106 and 108 each include base stations, operable to wirelessly communicate with UEs within signal range based on corresponding radio access technologies (RATs). Examples of the base stations include, for example, a NodeB (or base transceiver station (BTS)) for a Universal Mobile Telecommunications System (UMTS) RAT implementation (also known as “3G”), an enhanced NodeB (eNodeB) for a Third Generation Partnership Project (3GPP) Long Term Evolution (LTE) RAT implementation, a 5G node B (“gNB”) for a 3GPP Fifth Generation (5G) New Radio (NR) RAT implementation, and the like. As is well known in the art, the base station operates as an “air interface” that establishes radio frequency (RF) wireless connections with UEs, and these wireless connections (or “links”) then serve as data and voice paths between the UEs and the core networks for providing various services to the UEs, including voice services via circuit-switched networks or packet-switched networks, messaging services such as simple messaging service (SMS) or multimedia messaging service (MMS), multimedia content delivery, presence services, and the like. For purposes of description, it is assumed that the RAN 106 is an LTE RAN, and the RAN 108 is a 5G RAN. However, it will be understood that the techniques described herein can be applied to different types and combinations of RANs.

As noted above, the UE 102 can connect to the PDN 110 via either of the RANs 106 and 108. The UE 102 is capable of communicating (sending and receiving) data with the PDN 110 via either connection, and at different times can select a different one of the RANs. For example, in some embodiments the UE 102 includes separate wireless modems to establish the RAN connections and can select between the connections by placing the modem for the non-selected connection in a low-power or other inactive mode. In other embodiments, the UE 102 includes one modem that is configurable to connect to either of the RANs 106 and 108.

In some embodiments, the RANs 106 and 108 have different network characteristics and capabilities, and the UE 102 includes a power management module (not shown at FIG. 1) that selects between the RANs 106 and 108 based on a combination of the different network characteristics and capabilities and the network demands of programs executing at the UE 102. For example, in some embodiments, a connection to the LTE RAN 106 requires the UE 102 to consume power at a relatively low rate but supports a relatively low network throughput. In contrast, a connection to the 5G RAN 108 supports a relatively high network throughput but requires the UE 102 to consume power at a relatively high rate. The power management module monitors the throughput demands of the programs executing at the UE 102 and, in response to the throughput demands exceeding a threshold, can connect the UE 102 to the 5G RAN 108. When the throughput demands of the executing programs fall below the threshold, the power management module can disconnect the UE 102 from the 5G RAN 108 and can connect the UE 102 to the LTE RAN 106, thereby consuming less power. It will be appreciated that, in other embodiments, the power management module can employ different or additional network and UE characteristics to determine when to connect to each of the RANs 106 and 108.

In some cases, allowing the power management module full control over selection of the RANs 106 and 108 can result in the 5G RAN 108 being used rarely, or not being used at all. For example, in some cases the usage pattern of the UE 102 by the user is such that the network throughput threshold is rarely met, and the power management tool would therefore rarely connect the UE 102 to the 5G RAN 108. This can result in a poor user experience, such as when the user is paying subscription fees for the 5G RAN 108 but experiencing relatively few connections to that network. Accordingly, in some embodiments the UE 102 is configured to connect the UE 102 to the 5G RAN 108 for a minimum connection time 105. In some embodiments, the minimum connection time 105 indicates an amount of time per specified period of time. For example, in some embodiments the minimum connection time 105 indicates the amount of time the UE 102 is to connect to the 5G RAN 108 for each 24-hour period.

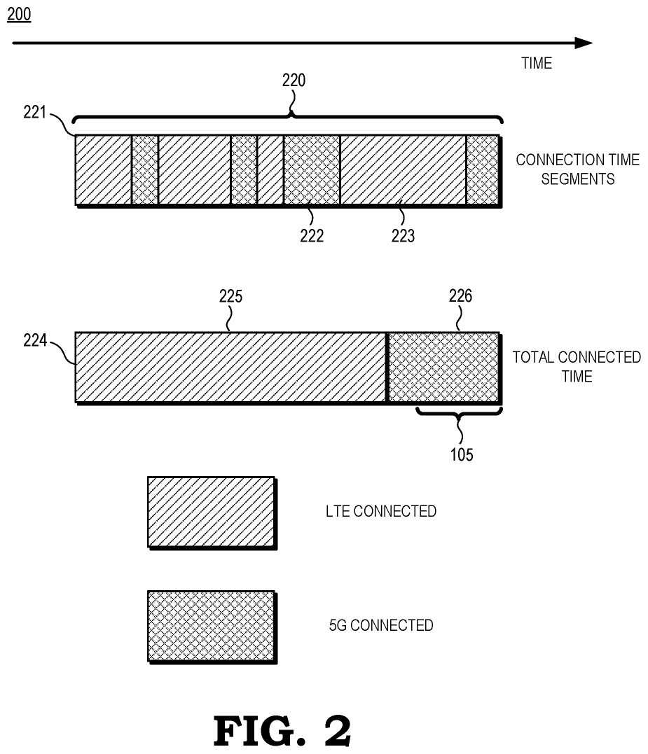

An example of the UE 102 enforcing a minimum connection time to the 5G RAN 108 is illustrated at FIG. 2 in accordance with some embodiments. FIG. 2 is a block diagram 200 illustrating the connection of the UE 102 to the RANs 106 and 108 over a period of time 220. For purposes of the example of FIG. 2, it is assumed that the period of time 220 is a 24-hour period, but in other embodiments the period of time 220 can be an hour, a week, or any other period of time.

Block 221 represents the segments of time (e.g., segments 222 and 223), over the period of time 220, that the UE 102 is connected to the RANs 106 and 108. The RAN connection, for a given segment of time, is represented by the crosshatch fill of the corresponding portion of block 221. Thus, for example, during segment 222 the UE 102 is connected to the 5G RAN 108, while during segment 223 the UE 102 is connected to the LTE RAN 106. Accordingly, in the illustrated example, over the time period 220, the UE 102 is connected to each of the RANs 106 and 108 for different, non-contiguous segments of time.

Block 224 represents the total time, over the time period 220, that the UE 102 is connected to each of the RANs 106 and 108. Block 224 includes two segments 225 and 226, with segment 225 representing the total amount of time, over the time period 220, that the UE 102 is connected to the LTE RAN 106, and with segment 226 representing the total amount of time that the UE 102 is connected to the 5G RAN 108. In operation, the UE 102 manages the connections to the LTE RAN 106 and the 5G RAN 108, over each period of time 220, to ensure that the segment 226 is at least as long as the minimum connection time 105.

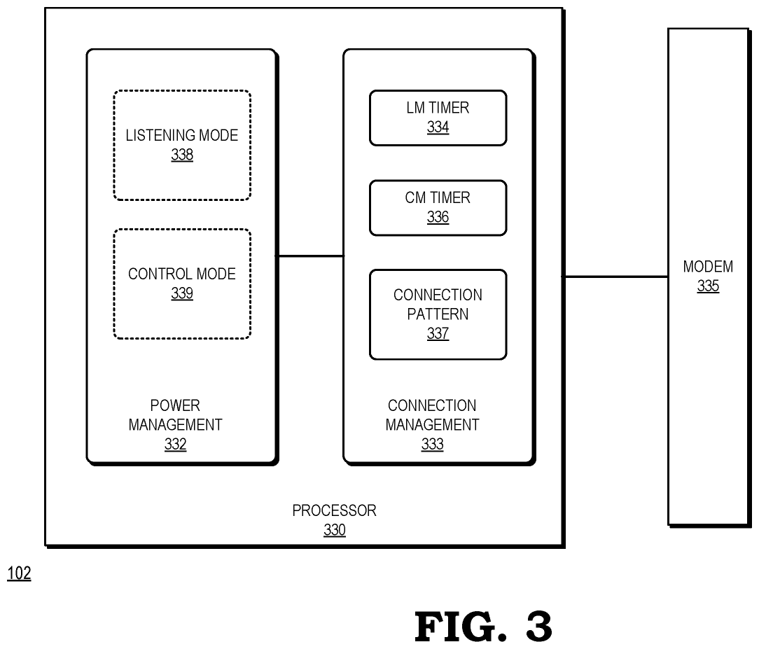

In different embodiments, the UE 102 can enforce the minimum connection time 105 in a variety of different ways, including by connecting to the RANs 106 and 108 according to a specified pattern of connection times. An example is illustrated at FIG. 3 in accordance with some embodiments. FIG. 3 illustrates a particular embodiment of the UE 102 including a central processing unit (CPU) or other general processor 330 and a modem 335. In some embodiments, the UE 102 includes additional circuitry to support wireless network connections, such as a Wi-Fi transceiver, at least one Wi-Fi antenna suitable for RF signaling and signal processing in one or more frequency bands typically associated with Wi-Fi connections, an RF transceiver, and at least one RF antenna suitable for RF signaling and signal processing in frequency bands associated with cellular RATs. Further, it will be appreciated that the UE 102 can include a number of additional components omitted from FIG. 3 for ease of illustration, including, for example, one or more displays, one or more touchscreens, keypads, mice, touchpads, microphones, speakers, and other user input/output devices, one or more sensors, batteries or other power sources, graphical processing units (GPUs) or other coprocessors, system memory, and the like.

As a general operational overview, the general processor 330 executes executable instructions from a software stack that includes an operating system (OS) and one or more user software applications, and which further can include the protocol stacks executed by processors of the modem 335. The OS manages the general operation of the various hardware components of the UE 102 as well as supports the execution of the one or more user software applications, with the user software applications typically accessed from system memory (not shown) for execution by the general processor 330. During execution, one or more processes of the OS or the user software application (referred to generally as “local processes”) may seek to wirelessly communicate data with the PDN 110.

In the event that a local process is seeking to communicate data with the PDN 110, the general processor 330 can employ a cellular RAN connection to one of the RANs 106 and 108, communicating data via the RF modem 335. The modem 335 can handle lower level operations associated with the corresponding network protocol, such as some or all of the physical, data link, and network layers, while the OS and the user software application executing at the general processor 330 support the higher-level layers of the network protocol, such as the transport, session, presentation, and application layers.

In some embodiments, the modem 335 can report link-layer information or other information indicative of a link quality for the current network connection. Examples of such link-layer information include a link speed, a channel utilization, and a packet error rate for one or both of an uplink portion and a downlink portion of the network connection. Based on the link-layer or other information, the OS can generate a throughput score for the current connection.

In some embodiments, the operating system executing at the general processor 330 selects between RANs 106 and 108 for data communication, based on the throughput score for each connection and based on the throughput demands of executing applications, while ensuring a minimum connection time to the 5G RAN 108. To support selection between the RANs 106 and 108, the OS executes a power management module 332 and a connection management module 333. The connection management module 333 is generally configured to select between the RANs 106 and 108 for data communication based on information provided by the power management module 332 and to ensure the minimum connection time to the RAN 108.

To illustrate, the power management module 332 is configured to execute in each of two different modes, a listening mode 338 and a control mode 339, with the mode selected by the connection management module 333. In the control mode 339, the power management module 332 monitors the throughput demands of the applications executing at the processor 330 and, based on the throughput demands, sends control signaling to the connection management module 333 to connect the UE 102 to one of the RANs 106 and 108 via the modem 335. For example, in the control mode 339 and in response to the throughput demands exceeding a specified threshold, the power management module 332 signals the connection management module 333 to connect to the 5G RAN 108, thereby ensuring that the throughput demands are met by the higher throughput of the 5G network. In response to the throughput demands falling below the threshold, the power management module 332 signals the connection management module 333 to disconnect from the 5G RAN 108 and to connect to the LTE RAN 106, thereby conserving power.

In the listening mode 338, the power management module 332 continues to monitor the throughput demands of the executing applications but does not issue control signaling to the connection management module 333 based on the throughput demands or other power management factors. Thus, while the power management module 332 is in the listening mode 338, the network connection is controlled by the connection management module 333. By setting the mode of the power management module 332 over time, the connection management module 333 can ensure the UE 102 is connected to the 5G RAN 108 for the minimum connection time 105.

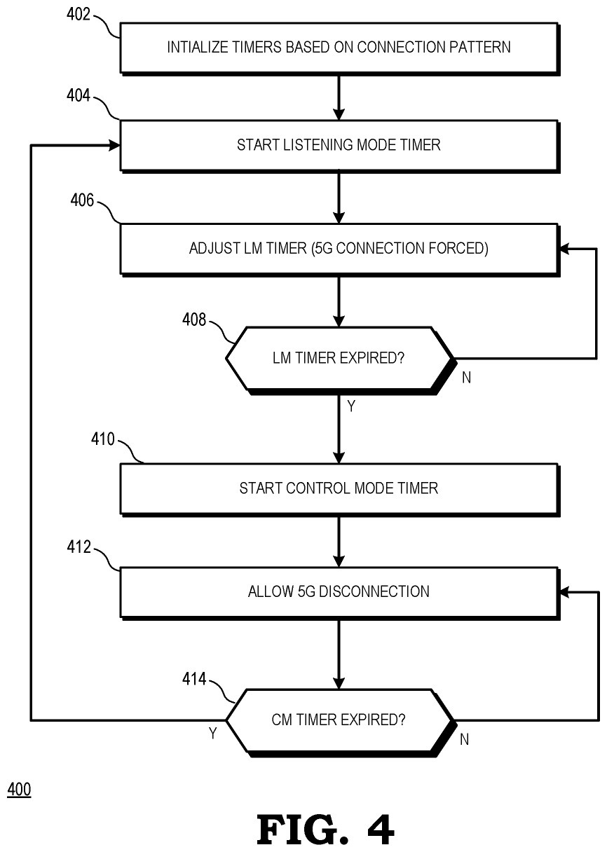

To illustrate, in the embodiment of FIG. 3, the connection management module 333 includes a listening mode (LM) timer 334, a control mode (CM) timer 336, and a connection pattern 337. In some embodiments, the connection pattern 337 is set by a carrier associated with the RANs 106 and 108 and indicates a specified time pattern for the UE 102 to be connected to the 5G RAN 108. The carrier sets the connection pattern 337 to ensure that the UE 102 is connected to the 5G RAN 108 for at least the minimum connection time 105. The connection management module 333 sets the LM timer 334 and CM timer 336 based on the connection pattern 337, and sets the mode of the power management module 332 based on expiration of the timers 334 and 336, thereby ensuring that the UE connects to the LTE RAN 106 and to the 5G RAN 108 according to the connection pattern 337. This can be understood with reference to FIG. 4, which depicts a flow diagram of a method 400 of managing connections to the RANs 106 and 108 at the UE 102 in accordance with some embodiments.

At block 402, the connection management module 333 initializes the LM timer 334 and the CM timer 336 to corresponding initial values indicated by the connection pattern 337. In some embodiments, the connection management module 333 executes this initialization at the beginning of each specified period 220 (FIG. 2), such as at the start of each 24-hour period. At block 404, the connection management module 333 places the power management module 332 in the listening mode 338 and instructs the modem 335 to connect to the 5G RAN 108. At block 406, the UE 102 adjusts the LM timer 334 while the UE 102 is forced to be connected to the 5G RAN 108. At block 408, the connection management module 333 determines if the LM timer 334 has expired (e.g., whether the LM timer 334 has reached zero or another specified threshold value). If not, the method returns to block 406 and the connection management module 333 maintains the power management module 332 in the listening mode.

In response to the timer expiring at block 408, the method flow moves to block 410 and the connection management module 333 places the power management module 332 in the control mode 339 and starts the CM timer 336. At block 412, the UE 102 adjusts the CM timer 336, while the power management module 332 controls the selection of the RANs 106 and 108 for connection. Thus, during the time period represented by block 408, the power management module 332 is permitted to instruct the connection management module 333 to connect and disconnect from the RAN 108 and the LTE RAN 106 based on performance and power management criteria such as throughput demands, available battery life at the UE 102, and the like. At block 414, the connection management module 333 determines if the CM timer 336 has expired. If not, the method flow returns to block 412 as the power management module 332 remains in the control mode 339. If, at block 414, the CM timer 336 has expired, the connection management module resets the timers 334 and 336, places the power management module 332 in the listening mode 338, and the method flow returns to block 404.

According to the method 400, by setting the connection pattern 337 to initialize the timers 334 and 336 to appropriate values, a carrier associated with the 5G RAN 108 can seta duty cycle for the UE 102 to connect to each of the RANs 106 and 108. For example, the carrier can set a 50% duty cycle, such that the UE 102 is connected to the RANs 106 and 108 for a substantially equal amount of time, by setting the connection pattern 337 so that the timers 334 and 336 are initialized to the same values. In some embodiments, the connection pattern 337 sets a ratio of connection times based on, for example, a listen mode ratio that establishes the percentage of time that the power management module 332 is to be in the listening mode 338. In these embodiments, the UE 102 is connected to the 5G RAN 108 for a minimum of time X, where X is given by the following formula:

X=Period Time*Listen Mode Ratio

where Period Time is the time period 220. The power management module 332 is in the listening mode 338 for the time X, and is in the control mode for a time Y, where Y is given by the following formula:

Y=Period Time*(1−Listen Mode Ratio)

In some embodiments, the connection management module 333 can adjust the values for X and Y, for each time period 220 (e.g., for each 24-hour period) based upon the connection time to the 5G RAN 108 for the previous time period 220 (e.g., for the previous 24-hour period) to maintain the overall pattern indicated by the connection pattern 337. Thus, for example, in some embodiments the connection pattern 337 specifies a 50% duty cycle, so that the UE 102 is to be connected to the 5G RAN 108 at least 50% of the time. Accordingly, for the initial time period 220, the connection management module 333 sets the power management module 332 to the listening mode 338 for 50% of the time period and to the control mode 339 for 50% of the time period. The connection management module 333 also monitors the total connection time of the UE 102 to the 5G RAN 108 and adjusts the duty cycle for the next time period based on this total connection time. For example, if the connection management module 333 determines that, for the initial time period, the UE 102 has connected to the 5G RAN 108 for 75% of the initial time period, the connection management module 333 adjusts the connection pattern 337 so that, for the next time period 220, the power management module 332 is in the listening mode 338 for only 25% of the time. The connection management module 333 thereby supports power conservation at the UE 102 while enforcing the overall duty cycle indicated by the connection pattern 337.

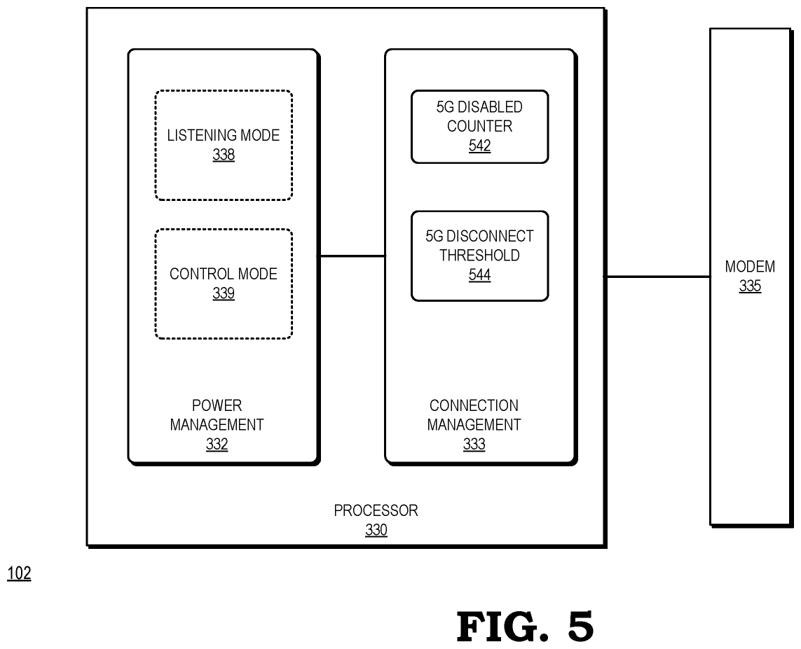

In some embodiments, the UE 102 enforces the minimum connection time 105 using an allowed time technique, so that the power management module 332 is placed in the control mode 339 until a threshold amount of 5G disconnection time is reached. An example is illustrated at FIG. 5 in accordance with some embodiments. FIG. 5 illustrates another example of the UE 102 including a modem 335, a processor 330, a power management module 332, with a listening mode 338 and a control mode 339, and a connection management module 333. Each of these components and modules is configured similarly to the example embodiment of FIG. 3, described above. However, in the example of FIG. 5, the connection management module 333 includes a 5G disabled counter 542 and a 5G disconnect threshold 544. The 5G disconnect threshold 544 indicates the maximum amount of time, for each time period 220, that the UE 102 is permitted to be disconnected from the 5G RAN 108. Thus, in some embodiments, the 5G disconnect threshold 544 is set by a carrier associated with the 5G RAN 108 to ensure that the UE 102 is connected to the 5G RAN 108 for the minimum connection time 105.

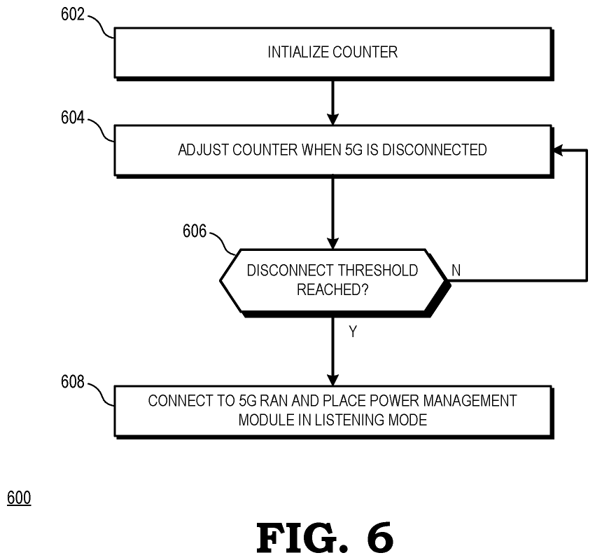

The operation of the UE 102 of FIG. 5 can be understood with reference to FIG. 6, which illustrates a flow diagram of a method 600 of managing connection of the UE 102 to the 5G RAN 108 in accordance with some embodiments. In some embodiments, the method 600 is applied for each time period 220. At block 602, at the start of the time period 220, the connection management module 333 initializes the counter 542 and places the power management module 332 in the control mode 339, so that the power management module 332 is permitted to prevent the UE 102 from connecting to the 5G RAN 108. At block 604, the connection management module 333 periodically adjusts (e.g., increments) the counter 542 during those segments of time when the power management module 332 has instructed the connection management module 333 to prevent connection to the 5G RAN 108. Thus, the value at the counter 542 represents the total time, during the time period 220, that the UE 102 has been prevented from connecting to the 5G RAN 108.

At block 606, the connection management module 333 compares the value at the counter 542 to the disconnect threshold 544. If the threshold has not been reached, the method returns to block 604 and the connection management module 333 maintains the power management module 332 in the control mode 339. In response to the value at the counter 542 reaching the disconnect threshold 544, the method flow moves to block 608 and the connection management module 333 instructs the modem 335 to connect to the 5G RAN 108. In addition, the connection management module places the power management module 332 in the listening mode 338 for the remainder of the time period 220, thereby preventing the power management module 332 from disconnecting the UE 102 from the 5G RAN 108 and ensuring that the minimum connection time 105 is satisfied.

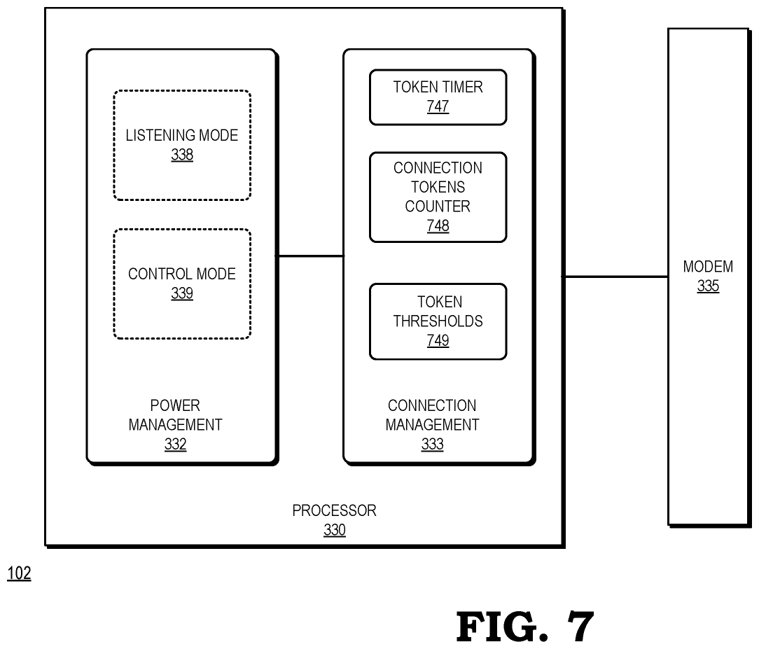

In some embodiments, the UE 102 employs a token-based scheme to control connection time to the 5g RAN 108. FIG. 7 illustrates an example configuration of the UE 102 that implements such a token-based scheme in accordance with some embodiments. In the illustrated example, the UE 102 includes a modem 335, a processor 330, a power management module 332, with a listening mode 338 and a control mode 339, and a connection management module 333. Each of these components and modules is configured similarly to the example embodiment of FIG. 3, described above. However, in the example of FIG. 7, the connection management module 333 implements a token-based control scheme using a token timer 747, a connection tokens counter 748, and token thresholds 749.

To illustrate, the connection management module 333 employs the connection tokens counter 748 to maintain a count of tokens, wherein each token represents an amount of time that the UE 102 is connected to the 5G RAN 108, and employs the token timer 747 to determine when to adjust the connection tokens counter 748 and thus to adjust the accumulated number of tokens. The token thresholds 749 is a data structure that stores a set of thresholds for the token-based scheme, including thresholds indicating 1) the threshold amount of time governing when the connection tokens counter is adjusted (referred to as the adjustment threshold); and 2) the threshold number of tokens governing when the connection management module 333 places the power management module in the control mode 339 (referred to as the control mode threshold).

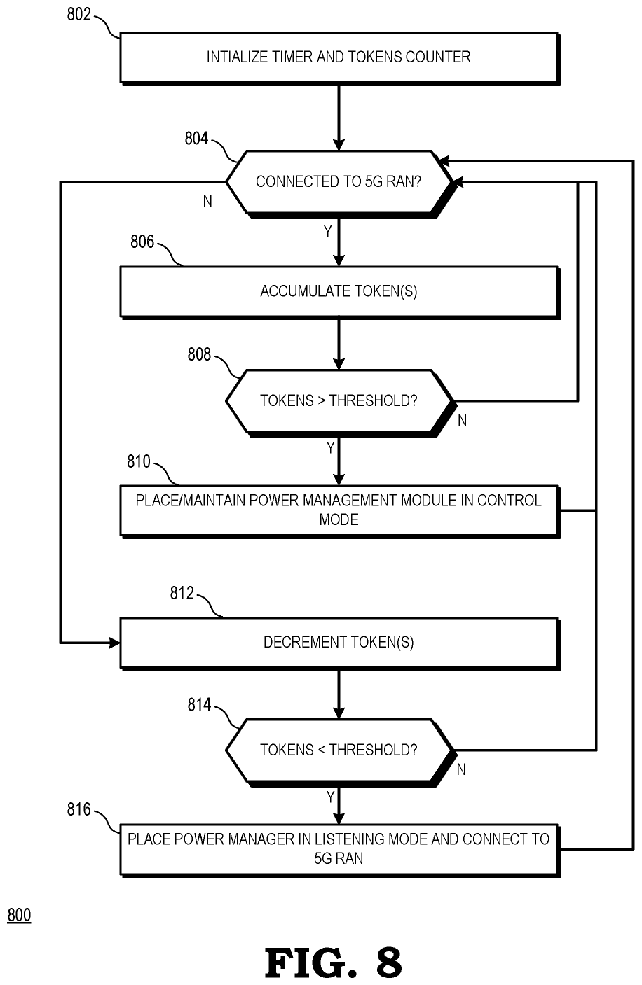

The implementation of the token-based scheme can be understood with reference to FIG. 8, which illustrates a flow diagram of a method 800 of selecting a RAN connection based on accumulated connection tokens in accordance with some embodiments. At block 802, the connection management module 333 initializes the token timer 747 and the connection tokens counter 748 to specified initial values (e.g., zero) and connects the UE 102 to the 5G RAN 108 in order to begin token accumulation. At block 804, the connection management module 333 determines if the UE 102 is connected to the 5G RAN 108. In some embodiments, the connection management module 333 executes the determination of block 804 each time the token timer 747 matches the adjustment threshold, and then resets the token timer 747 to its initial value. If the UE 102 is not connected to the 5G RAN 108, the method flow moves to block 812, described below.

If, at block 804, the connection management module 333 determines that the UE 102 is connected to the 5G RAN 108, the method flow proceeds to block 806 and the connection management module 333 accumulates one or more tokens by adjusting (e.g., incrementing) the value stored at the connection tokens counter 748. In some embodiments, the number of tokens accumulated at block 806 is set by a carrier associated with the 5G RAN 108 to control a duty cycle of connection times to the RAN 106 and the RAN 108, as described further below. At block 808, the connection management module 333 determines if the number of accumulated tokens (that is, the value stored at the connection tokens counter 748) exceeds the control mode threshold. If not, the method returns to block 804. If the number of accumulated tokens exceeds the threshold, the method flow moves to block 810 and the connection management module 333 places, or maintains, the power management module 332 in the control mode 339. The method flow returns to block 804.

If, at block 804, the connection management module 333 determines that the UE 102 is not connected to the 5G RAN 108 (e.g., because the power management module 332, while in the control mode 339, has instructed the connection management module 333 to disable 5G connection), the method flow moves to block 812 and the connection management module 333 reduces one or more tokens by adjusting (e.g., decrementing) the value stored at the connection tokens counter 748. At block 814, the connection management module 333 determines if the number of accumulated tokens is equal to or less than the control mode threshold. If not, the method flow returns to block 804. In response to the number of accumulated tokens equaling or falling below the control mode threshold at block 814, the method flow proceeds to block 816, and the connection management module 333 places the power management module 332 in the listening mode 338, and instructs the modem 335 to connect to the 5G network 108.

In some embodiments, a carrier associated with the 5G RAN 108, or other entity, can set the adjustment amounts for accumulating tokens (at block 806) and decrementing tokens (at block 812) to different values in order to change a duty cycle of connection times to the 5G RAN 108 and the LTE RAN 106. For example, by setting the adjustment amounts to equal values, the carrier can establish a duty cycle of about 50%, so that the UE connects to the LTE RAN 106 and the 5G RAN 108 for substantially equal amounts of time. By setting the adjustment amounts so that tokens are decremented at a faster rate than they are incremented, the carrier or other entity increases the amount of time the UE is connected to the 5G RAN 108. Similarly, by setting the adjustment amounts so that tokens are decremented at a slower rate than they are incremented, the carrier or other entity increases the amount of time the UE is connected to the 5G RAN 108.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying, at a user equipment (UE), a minimum connection time for a first radio access network (RAN);
connecting the UE to the first RAN for a first time and to a second RAN for a second time, the first time and the second time based on the minimum connection time.

2. The method of claim 1, wherein identifying the minimum connection time comprises identifying the minimum connection time based on a specified pattern of connection times to the first RAN and the second RAN.

3. The method of claim 2, wherein connecting the UE to the first RAN comprises:
setting a timer based on the specified pattern; and
connecting the UE to the first RAN in response to expiration of the timer.

4. The method of claim 1, wherein connecting the UE to the first RAN comprises:
connecting the UE to the first RAN in response to a counter reaching a threshold, the threshold based on the minimum connection time.

5. The method of claim 4, further comprising:
adjusting the counter in response to the UE being connected to the second RAN.

6. The method of claim 1, wherein identifying the minimum connection time comprises:
accumulating a number of connection tokens for the first RAN based on an amount of time the UE has been connected to the first RAN; and
identifying the minimum connection time based on the accumulated number of tokens.

7. The method of claim 6, further comprising:
reducing the accumulated tokens in response to the UE being connected to the second RAN.

8. A method, comprising:
connecting a UE to a first radio access network (RAN) for a first amount of time;
connecting the UE to a second RAN for a second amount of time, the second amount of time based upon a specified minimum connection time for the second RAN.

9. The method of claim 8, further comprising:
placing a power manager of the UE into a listening mode until the UE has
placing the power manager into a control mode in response to the UE being connected to the second RAN for the specified minimum connection been connected to the second RAN for the specified minimum connection time, the power manager unable to disconnect the UE from the second RAN while in the listening mode.

10. The method of claim 9, further comprising: time, the power manager able to disconnect the UE from the second RAN while in the control mode.

11. The method of claim 8, wherein the specified minimum connection time is based on an amount of time the UE has been connected to the second RAN over a specified time period.

12. The method of claim 8, wherein the specified minimum connection time is based upon a specified pattern of connection times to the first RAN and the second RAN.

13. The method of claim 8, further comprising:
accumulating a plurality of tokens based on an amount of time the UE is connected to the first RAN; and
wherein connecting the UE to the second RAN for the second amount of time comprises connecting the UE to the second RAN for an amount of time based on the accumulated plurality of tokens.

14. The method of claim 13, further comprising:
reducing the accumulated plurality of tokens based on the second amount of time.

15. A user equipment (UE) comprising:
a connection management module configured to identify, at a user equipment (UE), a minimum connection time for a first radio access network (RAN);
a modem configured to connect the UE to the first RAN for a first time and to a second RAN for a second time, the first time and the second time based on the minimum connection time.

16. The UE of claim 15, wherein the connection management module is to identify the minimum connection time by identifying the minimum connection time based on a specified pattern of connection times to the first RAN and the second RAN.

17. The UE of claim 16, wherein the connection management module is configured to:
set a timer based on the specified pattern; and
command the modem to connect the UE to the first RAN in response to expiration of the timer.

18. The UE of claim 15, wherein the connection management module is configured to:
command the modem to connect the UE to the first RAN in response to a counter reaching a threshold, the threshold based on the minimum connection time.

19. The UE of claim 18, wherein the connection management module is configured to:
adjust the counter in response to the UE being connected to the second RAN.

20. The UE of claim 15, wherein the connection management module is configured to identify the minimum connection time by:
accumulating a number of connection tokens for the first RAN based on an amount of time the UE has been connected to the first RAN; and
identifying the minimum connection time based on the accumulated number of tokens.
